(19) United States
(12) Patent Application Publication
(10) Pub. No.: US 2013/0074378 A1
(43) Pub. Date: Mar. 28, 2013

(54) Scoop and Dozer System with Lift Arms and Linkage Arrangement for Interchangeable Bucket and U-Blade

(71) Applicant: Michael P. May, Wamego, KS (US)

(72) Inventor: Michael P. May, Wamego, KS (US)

(73) Assignee: CATERPILLAR, INC., Peoria, IL (US)

(21) Appl. No.: 13/242,350

(22) Filed: Sep. 23, 2011

(51) Int. Cl. E02F 3/96; B23P 11/00

(52) U.S. Cl. 37/468; 29/428

(57) ABSTRACT

A scoop and dozer system disclosed for a wheel dozer. The scoop and dozer system includes right and left lift arms that may be coupled together by a distal cross beam. The lift arms include proximal portions and a distal hook-shaped portion that extends forward beyond the distal cross beam. The distal hook-shaped portions pivotally connect to a bucket. The distal cross beam provides a place for the location of a bracket that supports a single dump cylinder that extends upward into a central pocket disposed in the back of the bucket. The dump cylinder is protected from debris due to its raised position and placement inside a centralized pocket.

### TECHNICAL FIELD

This disclosure relates generally to wheel dozers, and more specifically to wheel dozers designed for dozing and loading lighter materials such as woodchips and coal. Still more specifically, this disclosure relates to an improved scoop and dozer system for such wheel dozers with an interchangeable bucket and blade and a common frame that provides an increased tilt function for both the bucket and blade.

### BACKGROUND

It is common practice to mount a bucket or blade to the front of a wheel dozer by a pair of lift arms. Each lift arm may be spaced from one another a distance that may be slightly narrower than the width of the bucket. The lift arms and the bucket are normally raised and lowered by a pair of lift cylinders that are connected to each lift arm or a crossbeam that connects the two lift arms together. Dump cylinders for the bucket are provided that are connected between the lift arms and the bucket. The bucket may be filled or dumped by actuating the pair of dump cylinders to pivot the bucket with respect to distal ends of the lift arms. The combination of the lift arms, lift cylinders, linkages, dump cylinders and bucket will be referred to herein as a “scoop assembly”.

Some wheel dozer buckets are specifically designed for moving and stockpiling lighter materials, such as coal, woodchips and other low density materials. The buckets increase production by being able to both doze and carry a load. Of course, different sizes of buckets are available for different machines and for different materials.

One problem associated with current designs for wheel dozers equipped with a bucket and linkages designed for loading lighter materials may be the exposure of the dump cylinders to the lighter materials. Specifically, the woodchips and/or coal can become packed between the dump cylinders and the bucket or between the dump cylinders and the lift arms, which can cause cylinder damage and potential failure. If one of the dump cylinders fails, the second dump cylinder may be prone to binding and premature failure.

Another problem associated with current bucket designs for lighter materials relates to the center of gravity of current bucket designs. Specifically, current bucket designs have a center of gravity that may be disposed a substantial distance from the wheel dozer and low to the ground thereby requiring the wheel dozer to provide a substantial amount of torque in order to lift the bucket.

Some wheel dozers include a tilt function which enables the bucket and the lift arms to tilt to the left or right or about a longitudinal axis that passes between and parallel to the lift arms. One tilt function may be provided by a tilt cylinder, one end of which may be mounted directly or indirectly to the wheel dozer and the other end of which may be mounted to one of the lift arms. Retraction or extension of the tilt cylinder causes the frame formed by the lift arms and cross beams to tilt to the right or left, dependent upon which arm the tilt cylinder may be connected to. Other tilt functions are provided by special bearing and linkage arrangements disposed between the work tool and the frame. See, e.g., U.S. Pat. No. 6,269,561. Because currently available buckets for light weight materials are also used for dozing, which may require a broader tilt range than the currently available range of 2°-3°, broader tilt ranges are desired.

Further, because buckets for light weight materials are generally not that versatile, it would be beneficial to have a quick and easy lift arm and linkage arrangement which would enable a bucket to be quickly and easily replaced with a blade or similar tool. Finally, current bucket designs for light weight materials typically include a lower cutting edge for facilitating dozing operations. Unfortunately, many current bucket designs for light weight materials place the cutting edge too low are too far below the surface when the bucket may be in the dump position, thereby putting undue strain on the wheel dozer when combining dumping and dozing operations.

### SUMMARY OF THE DISCLOSURE

In one embodiment, a scoop and dozer system is disclosed which is suitable for connection to a wheel dozer or other type of work vehicle. The disclosed scoop and dozer system includes a frame, a bucket, a dump cylinder, a blade and at least one pitch cylinder. The frame includes right and left lift arms. Each lift arm may include a proximal end, a proximal portion and a hook shaped distal portion with the proximal portion disposed between the proximal end and the hook shaped distal portion. Each hook shaped distal portion may terminate at a distal end. The right and left lift arms may be further coupled together by a distal cross beam. The bucket may include right and left side walls. The distal ends of the right and left lift arms may be pivotally connected to the right and left side walls respectively by first and second removable links respectively. The frame may be connectible to one end of the dump cylinder. The dump cylinder has another end that is connectible to the bucket by a third removable link. Wherein, upon removal of the first through the third removable links, the bucket and dump cylinder may be disconnected from the right and left lift arms and the distal cross beam. The blade may include a front and a rear. The rear of the blade may be connectible to the distal cross beam by a fourth removable link. The at least one pitch cylinder may be connected to the frame by a fifth removable link. The at least one pitch cylinder may also be connectible to the rear of the blade by a sixth removable link.

In another embodiment, a scoop and dozer system is disclosed which includes a frame, a bucket, a dump cylinder, a pair of tilt cylinders, a blade and a pair of pitch cylinders. The frame includes right and left lift arms. Each lift arm may include a proximal end, a proximal portion and a hook shaped distal portion. Each proximal portion may be disposed between its respective proximal end and the hook shaped distal portion. Each hook shaped distal portion may terminate at a distal end. The right and left lift arms may be coupled together by a distal cross beam. The proximal ends of the right and left lift arms are coupled to right and left tilt levers respectively. The proximal portions of the right and left lift arms may include right and left cylinder brackets respectively. The right tilt cylinder may be coupled to the right tilt lever and the right cylinder bracket. The left tilt cylinder may be coupled to the left tilt lever and the left cylinder bracket. The bucket may include right and left side walls and a curved wall disposed therebetween. The right side wall may include a right pocket with a rear opening for receiving the distal end and at least part of the distal portion of the right lift arm. The left side wall may include a left pocket with a rear opening for receiving the distal end and at least part of the distal portion of the left lift arm. The distal ends of the right and left lift arms may be pivotally connected to the right and left side walls respectively while being disposed inside the right and left pocket respectively. The bucket may further include a center pocket with a rear opening. The dump cylinder may be pivotally connectible to the distal cross beam and the central pocket of the bucket. Wherein, upon disconnecting the dump cylinder from the distal cross beam and the central pocket and upon disconnecting the distal ends of the right and left lift arms from the right and left side walls respectively, the bucket and dump cylinder may be disconnected from the frame. As a replacement for the bucket, the blade may include a front and a rear. The rear may be connectible to the distal cross beam. The right pitch cylinder may be connectible to the right cylinder bracket and the rear of the blade. The left pitch cylinder may be connectible to the left cylinder bracket and the rear of the blade.

In another embodiment, a method is disclosed for providing a scoop assembly and converting the scoop assembly to a dozing assembly. The method includes providing a frame, a bucket and a dump cylinder. The frame includes right and left lift arms. Each lift arm may include a proximal end, a proximal portion and a hook shaped distal portion with the proximal portion disposed between its proximal end and its hook shaped distal portion. Each hook shaped distal portion may terminate at a distal end. The right and left lift arms may be further coupled together by a distal cross beam. The bucket may include right and left side walls. The method may further include detachably connecting the distal ends of the right and left lift arms to the right and left side walls of the bucket respectively. The method may further include detachably connecting the distal cross beam to one end of the dump cylinder and detachably connecting the other end of the dump cylinder to the bucket to form the scoop assembly. The method may further include disconnecting the right and left lift arms from the right and left side walls respectively and disconnecting the dump cylinder from the bucket and distal cross beam. The method may further include providing a blade including a front and a rear and providing right and left pitch cylinders. The method may further include connecting the rear of the blade to the distal cross beam, connecting the right pitch cylinder to the right lift arm and to the rear of the blade and connecting the left pitch cylinder to the left lift arm and to the rear of the blade to provide the dozing assembly.

In any one or more of the embodiments described above, the links may be interchangeable.

In any one or more of the embodiments described above, the dump cylinder may be connectible to the distal cross beam.

In any one or more of the embodiments described above, the at least one pitch cylinder may include right and left pitch cylinders, wherein the right pitch cylinder is connectible to right lift arm and the left pitch cylinder is connectible to the left lift arm. In a further refinement of this concept, the rear of the blade may include right and left mounts. The right and left lift arms may include right and left cylinder brackets. The right and left pitch cylinders may be connectible to the right and left u-blade mounts respectively and to the right and left cylinder brackets respectively. In a further refinement of this concept, the system may further include right and left lift levers and right and left tilt cylinders. The right tilt cylinder may be connectible to the right tilt lever and the right cylinder bracket and the left tilt cylinder may be connectible to the left tilt lever and the left cylinder bracket.

In any one or more of the embodiments described above, the right and left cylinder brackets may be disposed on the proximal portions of the right and left lift arms respectively.

In any one or more of the embodiments described above, the right side wall of the bucket may include a right pocket with a rear opening for receiving the distal end and at least part of the distal portion of the right lift arm. The left side wall of the bucket may include a left pocket with a rear opening for receiving the distal end and at least part of the distal portion of the left lift arm.

In any one or more of the embodiments described above, the bucket may further include a curved wall disposed between the right and left side walls. The curved wall may include a central pocket with a rear opening for receiving at least part of the dump cylinder when the bucket is detachably connected to the distal cross beam and the bucket. In a further refinement of this concept, the dump cylinder may be disposed substantially in the central pocket throughout a range of motion provided by contracting and extending the dump cylinder. In another refinement of this concept, the distal ends of the right and left lift arms may be connected to the right and left side walls along a first axis that passes through the distal ends of the right and left lift arms. The end of the dump cylinder may be connectible to the central pocket at a first point that is disposed vertically above the first axis throughout a range of motion of the bucket provided by the dump cylinder. In another refinement of this concept, the first point may be disposed above the center of gravity of the bucket throughout a range of motion provided by contracting and extending the dump cylinder.

In any one or more of the embodiments described above, the distal ends of the right and left lift arms may have a first axis that passes through the distal ends of the right and left lift arms. Further, a center of gravity of the bucket may be disposed below the first axis throughout a range of motion provided by contracting and extending the dump cylinder.

In any one or more of the embodiments described above, the proximal cross beam may have right and left ends that are pivotally coupled to the proximal ends of the right and left lift arms respectively.

In any one or more of the embodiments described above, the system may further include a proximal cross beam having right and left ends that are pivotally coupled to the right and left tilt levers respectively.

In any one or more of the embodiments described above, the right and left tilt levers may be coupled to right and left spherical bearings. The right and left ends of the proximal cross beam may include right and left trunnions respectively. The right and left trunnions may be received in the right and left spherical bearings respectively. As a further refinement of this concept, the right and left spherical bearings each include a housing and a bearing insert for receiving one of the trunnions. Each housing may provide a translational degree of freedom for its respective bearing insert to slide within its respective housing without exiting the housing when the proximal ends of the right and left lift arms are tilted.

### BRIEF DESCRIPTION OF THE DRAWINGS

FIG. 1 is a rear perspective view of a prior art scoop assembly shown in a dump position.

FIG. 2 is a rear perspective view of a disclosed scoop assembly shown in a dump position.

FIG. 3 is another rear perspective view of the disclosed scoop assembly shown in FIG. 2 with the bucket in a rest position.

FIG. 4 is a front perspective view of the scoop assembly shown in FIGS. 2-3, with the bucket in a rest position.

FIG. 5 is an exploded view of the scoop assembly disclosed in FIGS. 2-4, particularly illustrating the ease in which the bucket may be removed from the frame.

FIG. 6 is a rear perspective view of the frame shown in FIGS. 2-5 with a blade attached to the frame, particularly illustrating the ease in which one can convert from use of a bucket (FIGS. 2-5) to use of a blade with the disclosed frame.

FIG. 7 is a partial rear perspective view of the frame and blade illustrated in FIG. 6, particularly illustrating the coupling of the pitch cylinders between the blade and the right cylinder bracket, which may also be used to support the right tilt cylinder which may extend between the right cylinder bracket and the right lever as shown in FIG. 7.

FIG. 8 is a side plan view of the frame and blade illustrated in FIGS. 6-7 with the pitch cylinders in a retracted position.

FIG. 9 is another side plan view of the frame and blade shown in FIGS. 6-8, with the pitch cylinders in a fully extended position thereby permitting the blade to dig below the ground line.

FIG. 10 is a side plan view of a disclosed scoop assembly with the bucket in a rest position.

FIG. 11 is a side view of a prior art scoop assembly with the bucket in a rest position.

FIG. 12 is a side view of a disclosed scoop assembly with the bucket in a dump position.

FIG. 13 is a side view of a prior art scoop assembly with the bucket in a dump position.

FIG. 14 is a side view of the disclosed scoop assembly with the bucket in a combination dozing and dumping position with the cutting edge of the bucket disposed below ground level.

FIG. 15 is a side view of a prior art scoop assembly in the a combination dozing and dumping position.

FIGS. 16-17 illustrate the disclosed scoop assembly in a mid-tilt-left position (FIG. 16) and a mid-tilt-right position (FIG. 17) wherein the mid-tilt positions may be obtained by extending or retracting one of the tilt cylinders only.

FIGS. 18-19 are rear views of the disclosed scoop assembly in a max-tilt-left position (FIG. 18) and a max-tilt-right position (FIG. 19), both of which require retraction of one tilt cylinder and extension of the other tilt cylinder.

FIGS. 20-21 are rear views of the disclosed frame and blade in the mid-tilt-right position (FIG. 20) and the mid-tilt-left position (FIG. 21), both of which may be obtained by extending or retracting one tilt cylinder or a combination of two tilt cylinders.

FIGS. 22-23 illustrate the disclosed frame and blade in the max-tilt-left position (FIG. 22) and the max-tilt-right position (FIG. 23), both of which may be obtained by extending one tilt cylinder and retracting the other tilt cylinder.

FIGS. 24-25 illustrates the differences in the distances between the bearing assemblies when the frame is in the max-tilt-left position (FIG. 24) and a level or no-tilt position (FIG. 25).

FIG. 26 is a plan view of a disclosed proximal cross beam.

FIG. 27 is a plan view of a prior art frame for connecting a bucket to a machine, and which particularly illustrates the problems associated with the tilt mechanism, particularly the max-tilt position which causes the proximal portions of the lift arms to be deflected inward.

FIG. 28 is a partial view of a disclosed frame equipped with a spherical bearing and housing that provides freedom for lateral movement of the spherical bearings with respect to the trunnions attached to the proximal cross beam during a tilting of the frame.

FIG. 29 is an enlarged view of the spherical bearing and housing shown in FIG. 28.

FIG. 30 is a front plan view of the spherical bearing and housing shown in FIGS. 28-29.

FIGS. 31-32 are partial views of the disclosed bucket assemblies, particularly illustrating the pivotal movement of the disclosed spherical bearing and housing (with the cover portion removed), as mounted on the right tilt lever and showing the right tilt cylinder in a fully extended position (FIG. 31) and a fully retracted position (FIG. 32).

### DETAILED DESCRIPTION

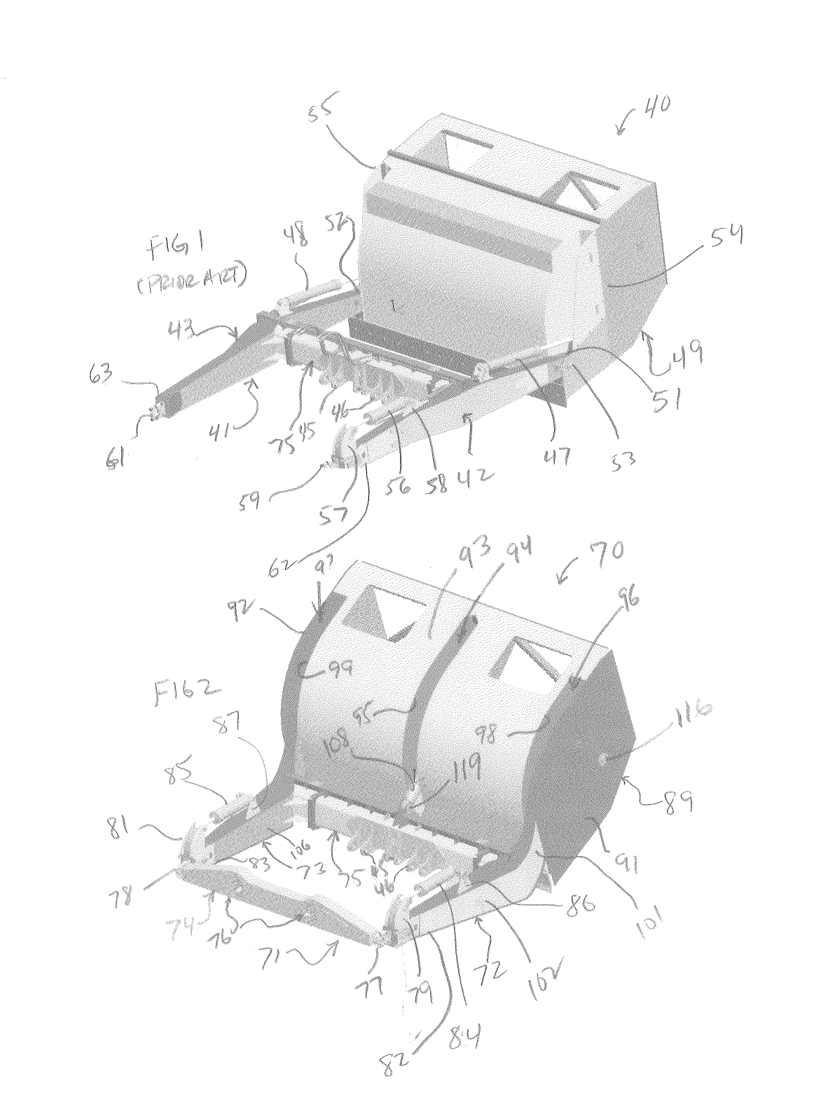

Comparing FIGS. 1 and 2, two scoop assemblies 40, 70 are disclosed respectively. The prior art scoop assembly 40 of FIG. 1 may include an H-shaped frame 41 that may include a right lift arm 42, a left lift arm 43 and a cross beam 75. The cross beam 75 may include brackets 45, 46 for coupling to a pair of lift cylinders (not shown). The scoop assembly 40 may also include right and left dump cylinders 47, 48 respectively which will cause the bucket 49 to pivot about the distal ends 51, 52 of the lift arms 42, 43 respectively. Specifically, pins, one of which is shown at 53, may connect the distal ends 51, 52 of the lift arms 42, 43 to the right and left sides 54, 55 of the bucket 49.

Also shown in FIG. 1 is a tilt cylinder 56, which may be coupled to a tilt lever 57 and a cylinder bracket 58. The use of a single tilt cylinder 56 and conventional means for attaching the frame 41 to the machine may limit the tilt capability of the scoop assembly 40 to a range of from about 2° to about 3°. Further, conventional bearings 59, 61 are utilized which cause the proximal ends 62, 63 of the right and left lift arms 42, 43 respectively to deflect inward as the scoop assembly 40 is tilted because of the difference in distances between the bearings 59, 61. Specifically, the distance between the bearings 59, 61 in a no-tilt condition is shorter than when the frame is tilted by way of movement of the bearing 59 due to its attachment to the tilt lever 57. As a result, the scoop assembly 40 in FIG. 1, with its use of a single tilt cylinder 56 may provide a limited tilt magnitude ranging from about 2° to about 3°.

Turning to FIG. 2, a disclosed scoop assembly 70 is shown that may include a frame 71 that may include right and left lift arms 72, 73 that may be coupled together by two cross beams, including a proximal cross beam 74 and a distal cross beam 75. The proximal cross beam 74 may be fixed to the machine as indicated by the plurality of fasteners shown at 76. The proximal cross beam may also be coupled to the right and left lift arms 72, 73 by spherical bearing assemblies 77, 78 which may be coupled to the right and left tilt levers 79, 81 respectively. The right and left tilt levers 79, 81 may be coupled to the proximal ends 82, 83 of the right and left lift arm 72, 73 respectively. The right and left tilt levers 79, 81 may be used to support right and left tilt cylinders 84, 85 respectively. The right and left tilt cylinders 84, 85 may also be supported by right and left cylinder brackets 86, 87 respectively. Again, the brackets 44, 45 disposed on the distal cross beam 75 may be utilized for coupling the scoop assembly 70 to lift cylinders (not shown).

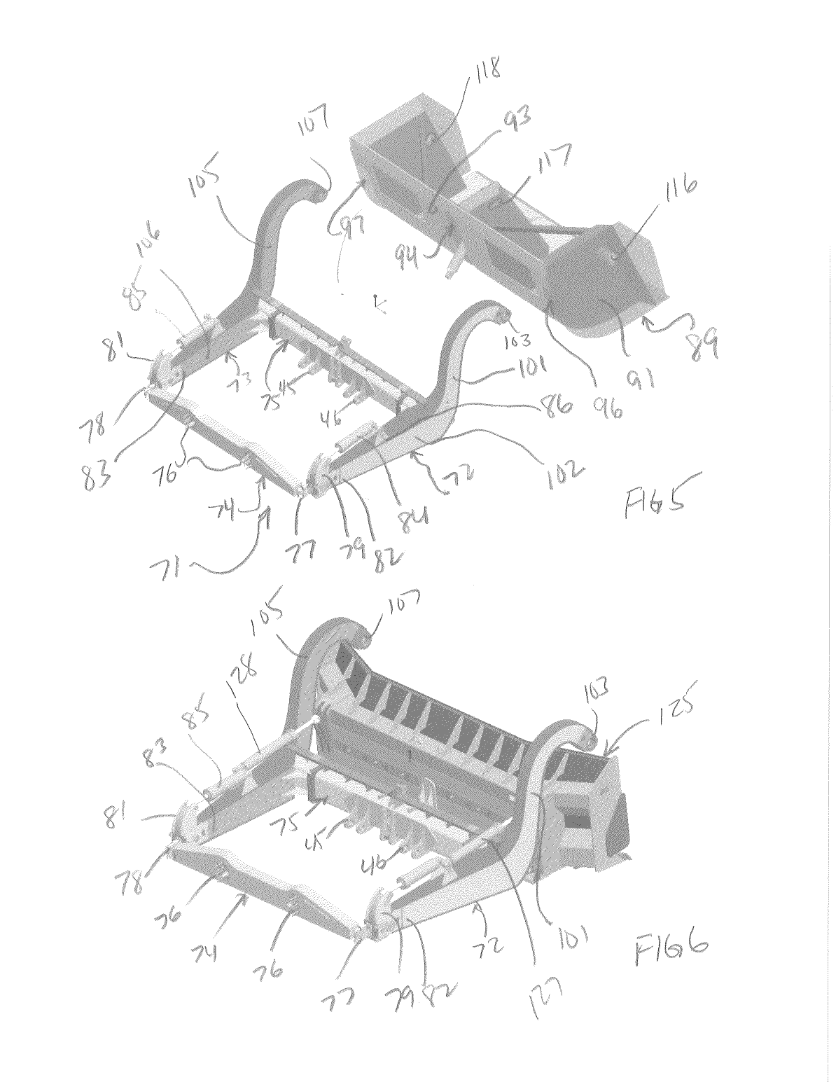

Still referring to FIG. 2, the scoop assembly 70 also may include a bucket 45 which may include a right wall 91, a left wall 92 and a curved wall 93 extending therebetween. The curved wall 93 may include a central pocket 94 with a rear opening 95. The curved wall 93 may also form right and left pockets 96, 97 respectively, both with rear openings 98, 99 respectively. The right pocket 96 may accommodate a distal portion 101 of the right lift arm 72 (see FIG. 5) which also may include a proximal portion 102, a distal end 103 and a proximal end 82. Returning to FIG. 2, the left pocket 97 may accommodate the distal portion 105 of the left lift arm 73, which also may include a proximal portion 106, a distal end 107 and a proximal end 83 as shown in FIG. 5.

Returning to FIG. 2, the central pocket 94 may accommodate the single dump cylinder 108 which may extend between the distal cross beam 75 and the inside of the central pocket 94. By placing the dump cylinder 108 inside the central pocket 94, the dump cylinder 108 is not exposed to dirt, debris, etc. as the dump cylinder is not in the path of material flow. Specifically, the dump cylinder 108 is positioned above the path of material flow which avoids packing of material between the dump cylinder 108 and any portion of the frame or any portion of the central pocket 94.

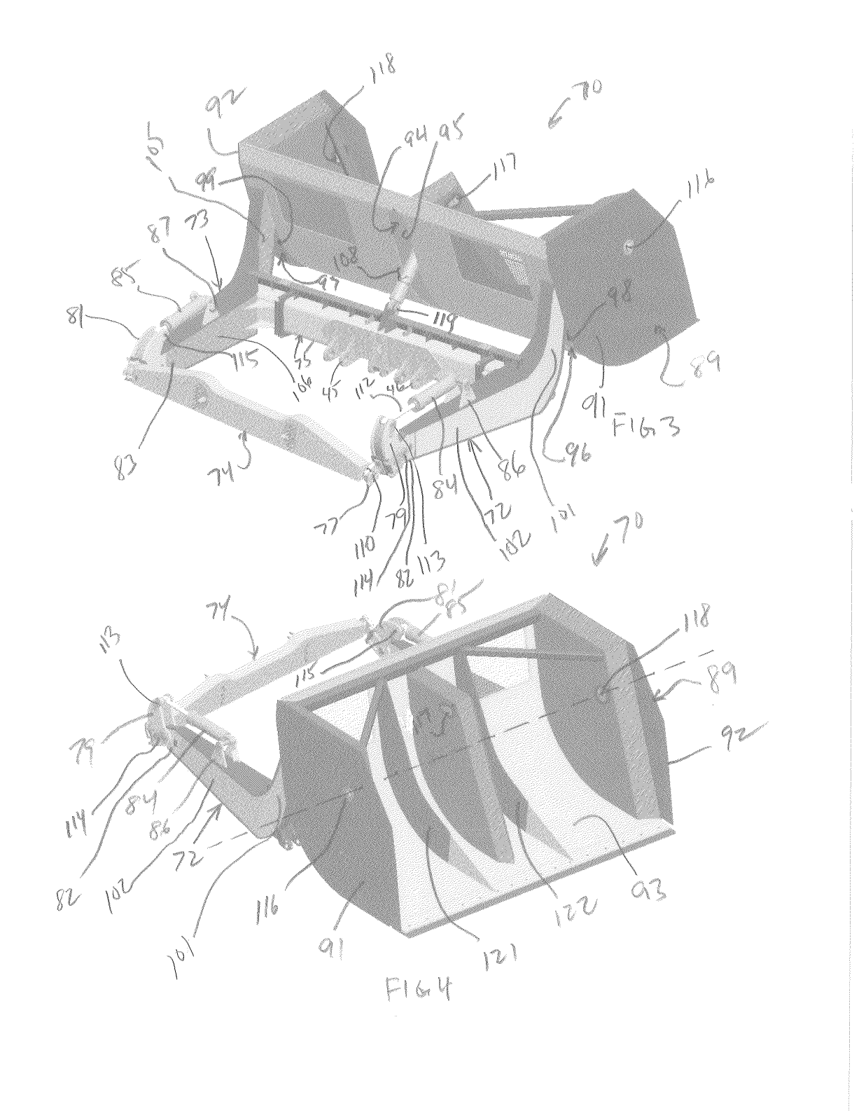

While FIG. 2 illustrates the scoop assembly 70 in a dump position, FIGS. 3 and 4 illustrate the scoop assembly 70 in a tilted position. Specifically, in FIGS. 3 and 4, the right tilt cylinder 84 may be extended and the left tilt cylinder 85 may be retracted. As one can see in FIGS. 3 and 4, with the right tilt cylinder 84 extended, the tilt lever 79 must pivot away from the cylinder 84 due to the fixed position of the right cylinder bracket 86. The reader will also note that bearing assembly 77 receives the right trunnion 110 of the proximal cross beam 74 (see FIG. 26), which also may include a left trunnion 111. Returning to FIGS. 3 and 4, the right tilt lever 79 may be coupled to the rod 112 that extends from the right tilt cylinder 84 by the link 113. The right tilt lever 79 may also be coupled to the proximal end 82 of the lift arm 72 by the link 114. Because the bearing assembly 77 supports the back of the right tilt lever 79 on the trunnion 110, as the rod 112 pushes the link 113 and the top of the right tilt lever 79 rearward or towards the proximal cross beam 74, the lower link 114 and the bottom of the tilt lever 79 pivot upward thereby raising the right lift arm 72.

In contrast, referring to the action of the left tilt cylinder 85, when the left tilt cylinder 85 is retracted, the link 115 and the top of the left tilt lever 81 moves forward and downward thereby causing the lower end (not shown in FIGS. 3-4) of the left tilt lever 81 that is coupled to the proximal end 83 of the left lift arm 73 to move downward thereby lowering the left lift arm 73 as the right lift arm 72 is raised. Also shown in FIGS. 3 and 4 are the links 116, 117, 118 that may be used to couple the right lift arm 72, dump cylinder 108 and left lift arm 73 to the right pocket 96, central pocket 94 and left pocket 97 respectively. FIG. 4 also illustrates the stiffening ribs 121, 122 disposed in the curved wall 93 of the bucket 45.

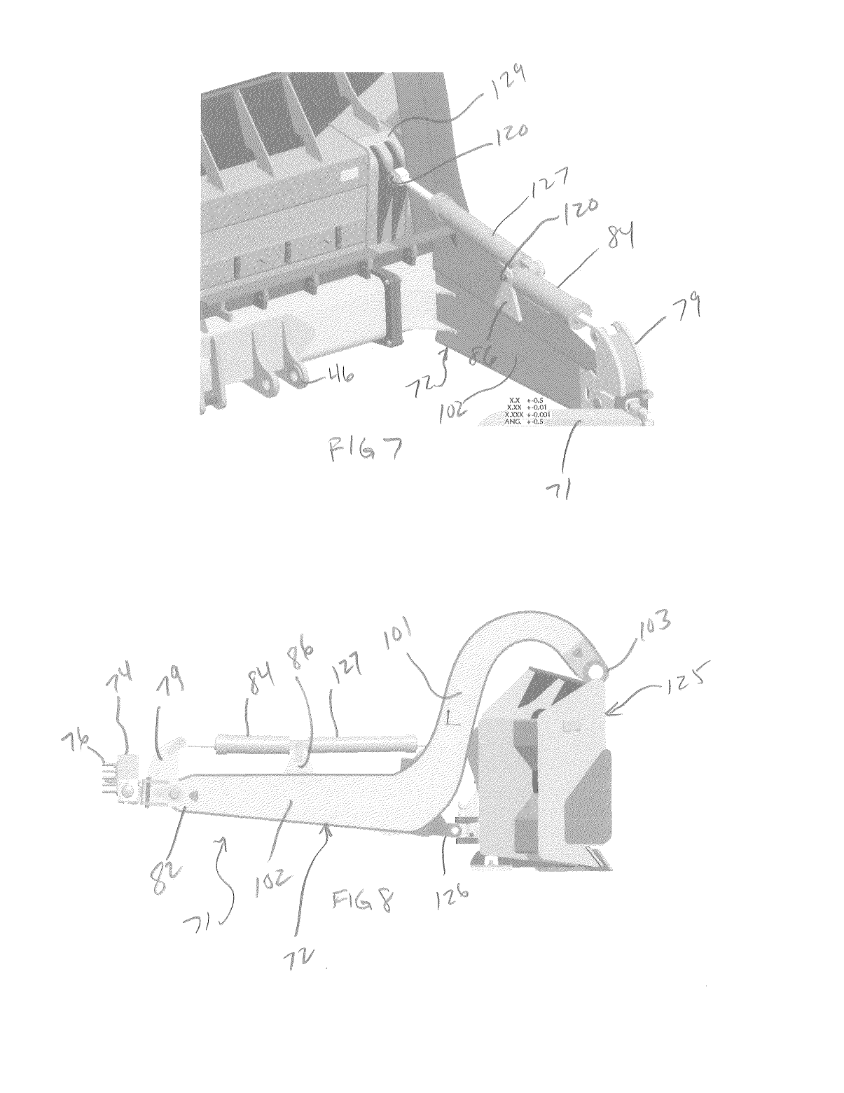

Turning to FIGS. 5 and 6, the ease in which the bucket 45 may be removed from the frame 71 is illustrated. Specifically, a pin may be removed that decouples the dump cylinder 108 from the dump cylinder bracket 109. Also, the pins 116, 118 that bridge the right and left pockets 96, 97 are removed thereby releasing the distal ends 103, 107 of the right and left lift arms 72, 73 from the bucket 45. With the bucket 45 removed, the blade 125 may be installed on the frame 71. Specifically, the front of the distal cross beam 75 may include a clevis 126 or other type of bracket or fixture for coupling to the rear of the blade 125 as illustrated in FIG. 8. Returning to FIG. 6, the blade may be further secured to the right and left lift arm 72, 73 by the right and left pitch cylinders 127, 128 respectively. The pitch cylinders 127, 128 may be secured to mounts 129 (FIG. 7), 131 (FIG. 6) as well as the right and left cylinder brackets 86, 87, which may also support the right and left tilt cylinders 84, 85 respectively.

Thus, the three links are removed to decouple the bucket 45 from the frame 71. Specifically, the links 116, 118 that secure the proximal ends 103, 107 of the right and left lift arms 72, 73 to the right and left pockets 96, 97 are removed as is the link 119 that secures the dump cylinder 108 to the bracket 109. Further, to secure the blade 125 to the frame 71, the clevis 126 (FIG. 8) may be coupled to the rear of the blade 125 and the pitch cylinders 127, 128 are installed using a total of four pins 120 (see FIGS. 6 and 7), two of which are already in place on the right and left cylinder brackets 86, 87. Thus, the transition between the bucket 45 and the blade 125 is fast and straight forward.

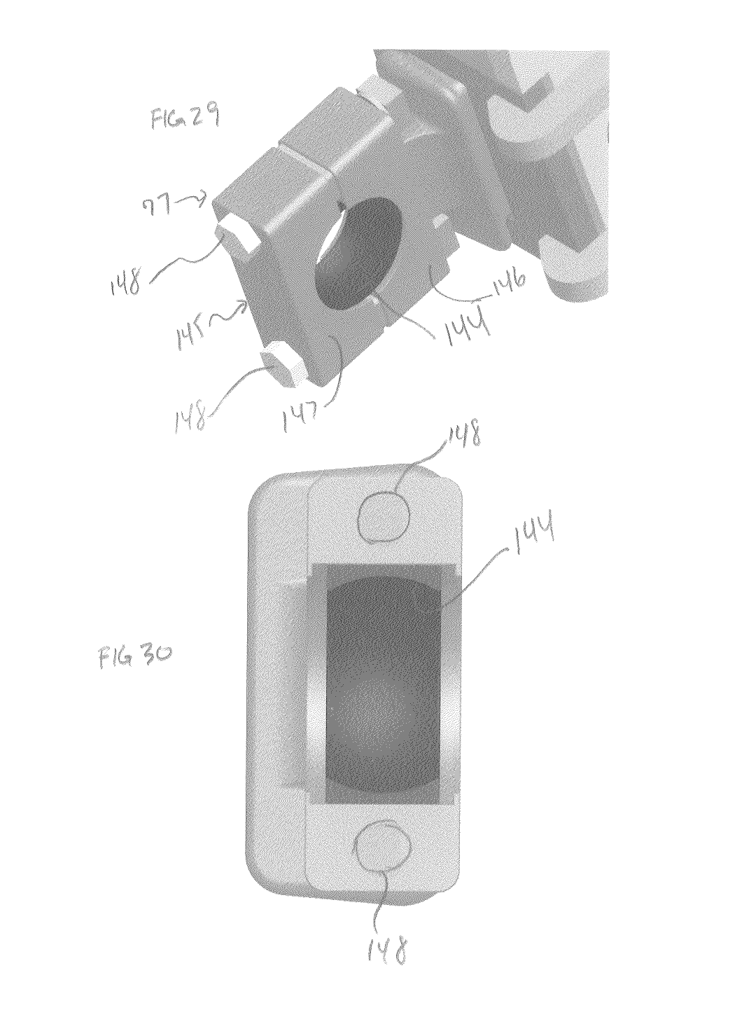

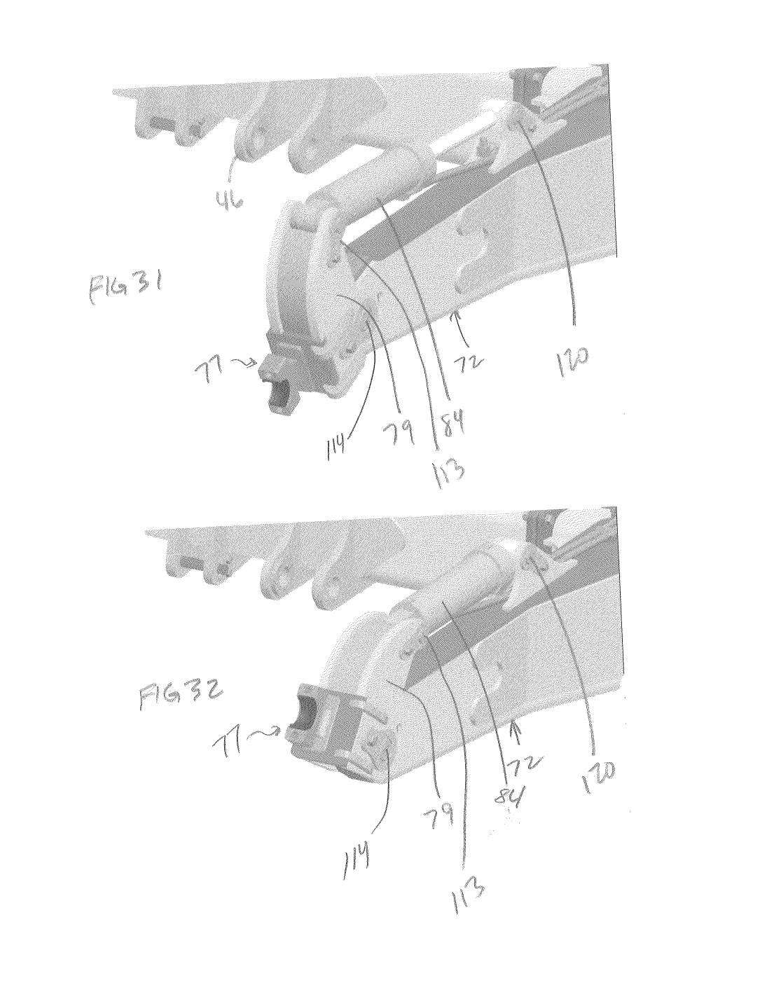

FIGS. 8 and 9 illustrate the frame 71 and blade 125 in the upright (FIG. 8) and pitched forward (FIG. 9) positions. Thus, the blade 125 may be installed with its full pitch function provided by the pitch cylinders 127, 128 in addition to a full tilt function provided by the tilt cylinders 84, 85 as explained in greater detail below in connection with FIGS. 16-32.

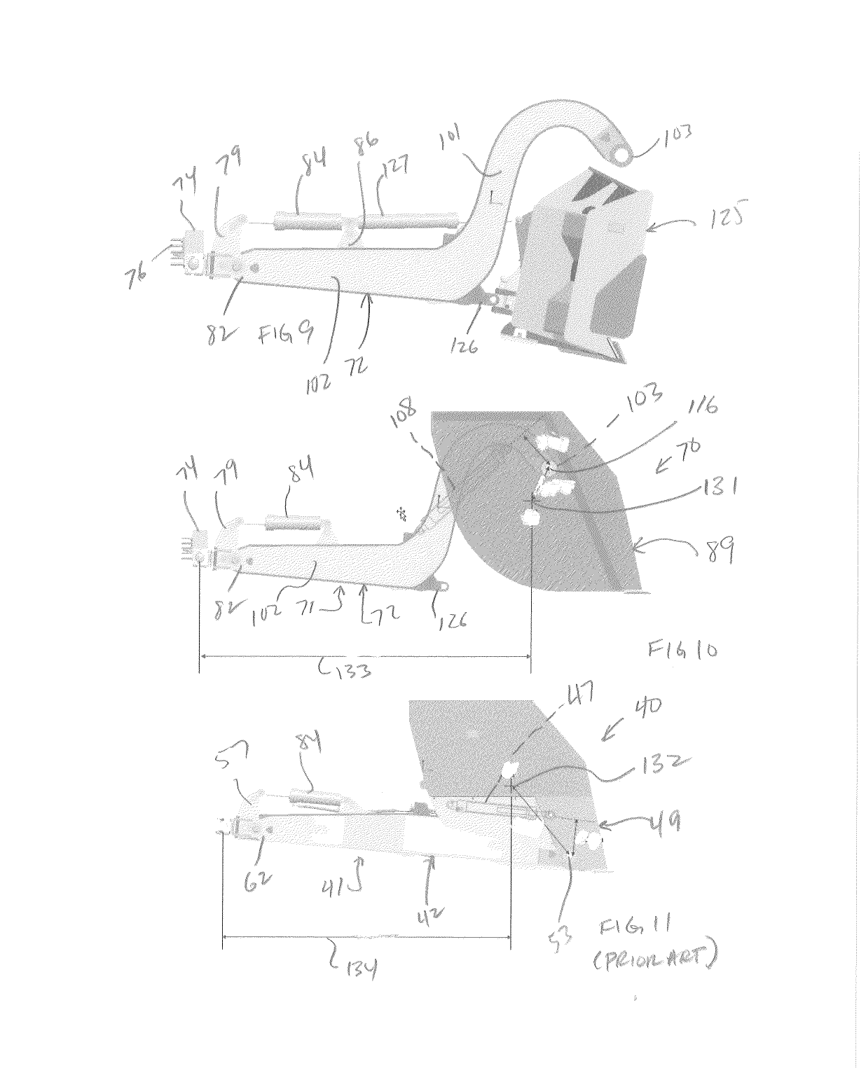

Returning to FIGS. 10-11, a comparison of the disclosed frame 71 with the S-shaped profile and the prior art frame 41 with the H-shaped profile (from a top view) is provided. Specifically, the S-shape profile of the lift arms 72, 73 raise the distal ends 103, 107 (FIG. 5) as well as the dump cylinder above ground level and above the proximal portions 102, 106 of the lift arms 72, 73. Because the dump cylinder 108 is disposed higher than the dump cylinders 47, 48 of the scoop assembly 40 (FIG. 11) and further because the dump cylinder 108 (FIG. 10) is out of the flow path of material and debris, there is very little chance that material and debris may be packed between the dump cylinder 108 and the central pocket 95 (FIG. 3) which thereby avoids the binding and dump cylinder failure experienced other designs. Referring to FIGS. 1 and 11, it is clear that the dump cylinders 47, 48 of FIG. 1 are exposed to flow of material around the bucket 49 which thereby enables material to be packed between the dump cylinders 47, 48 and the lift arms 42, 43.

Still referring to FIGS. 10 and 11, the center of gravity of the bucket 45 is shown at 131. In contrast, the center of gravity of the bucket 49 is shown at 132. By raising the distal ends 103, 107 of the lift arms 72, 73 upward, the center of gravity 131 also moves upward with respect to the center of gravity 132 and, in fact, for frames of the same size, the center of gravity 131 of the scoop assembly 70 may be about 5% higher than the center of gravity 132 of the conventional scoop assembly 40 when the buckets 45, 49 are in their rest positions. Further, the payload center of gravity 131 may be disposed about 8.5% farther forward or away from the machine (not shown) when the bucket 45 is in the rest position. In other words, the distance represented by the line 133 may be about 8.5% longer than the distance represented by the line 134.

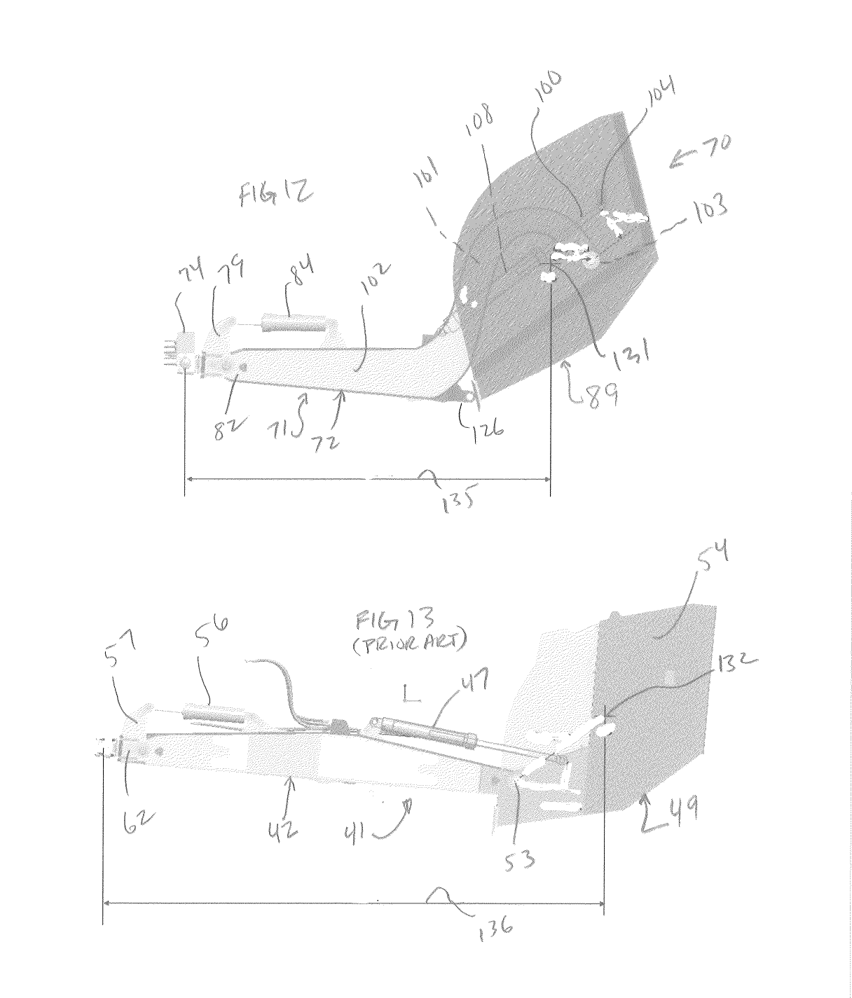

Referring to FIGS. 12-13, the capital S-shaped profile of the arms 72, 73 provides an additional advantage wherein, in the dump position, as shown in FIGS. 12-13, the center of gravity 131 for the bucket 45 of the disclosed scoop assembly 70 may be about 32% closer to the machine than the center of gravity 132 of the bucket 49. By having the center of gravity 131 closer to the machine, a tremendous mechanical advantage may be provided for the lift cylinders (not shown) as less force may be needed to maintain the lift arms 72, 73 in a raised position during a dumping operation. In other words, the distance represented by the line 135 may be about 32% shorter than the distance represented by the line 136. Additionally, a tremendous mechanical advantage may be provided for the return of the bucket to the rest position when the single dump cylinder is fully extended, as the bucket center of gravity would be in a position mechanically favorable for the retraction of the dump cylinder. Further, in the dump position shown in FIGS. 12-13, the center of gravity 131 for the bucket 45 may be 20% higher than the center of gravity 132 for the bucket 49. Thus, the center of gravity 131 may be disposed closer to the machine and at a higher position which provide a tremendous mechanical advantage for the lift cylinders (not shown) over the currently available design as illustrated in FIG. 13.

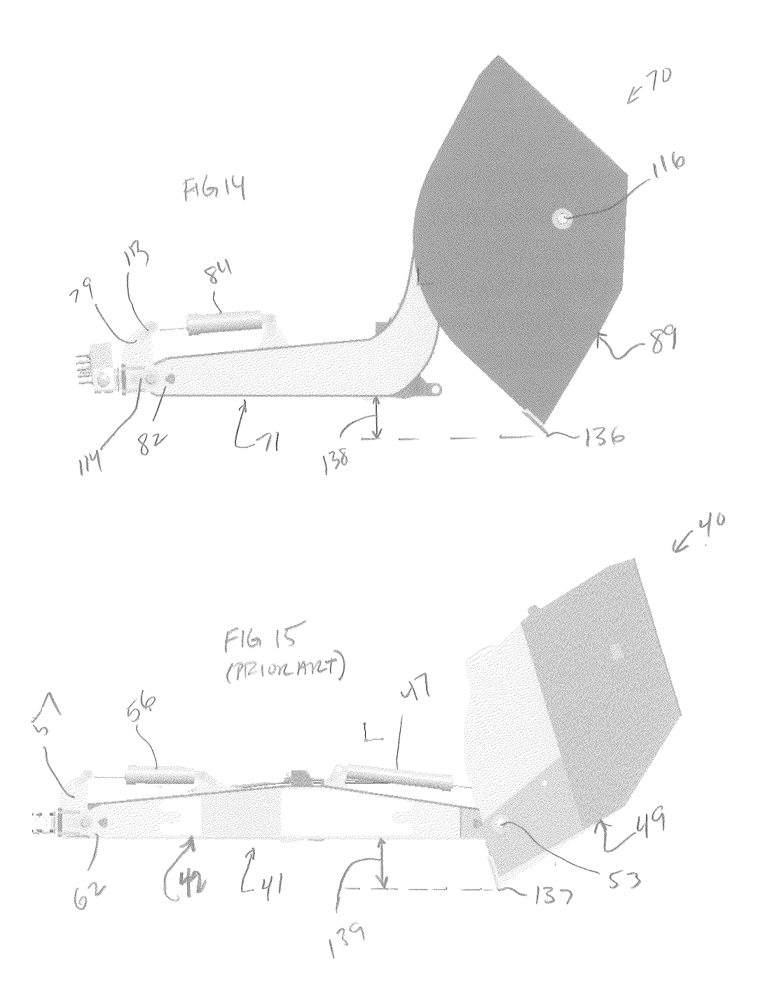

Turning to FIGS. 14-15, the scoop assemblies 70, 40 are shown in their respective dozing positions with the cutting edges 136, 137 respectively disposed below the bottom of their respective frames 71, 41. However, the cutting edge 137 of the bucket 49 may be disposed approximately 32% deeper than the cutting edge 136 of the bucket 45. In other words, the distance represented by the line 138 is approximately 32% shorter than the distance represented by the line 139.

Referring to FIGS. 2-3 and 16-19, the mechanisms for tilting the bucket 45 with respect to the stationary proximal cross beam 74 is illustrated. Turning first to FIG. 2, both tilt cylinders 84, 85 are disposed in a neutral position while the bucket 45 is disposed in a dump position with the dump cylinder 108 fully extended. In FIG. 3, the dump cylinder 108 has been retracted, but the bucket 45 is in a tilted left position. Specifically, as explained above in connection with FIG. 3, the right tilt cylinder 84 has been extended, thereby raising the right lift arm 72 while the left tilt cylinder 85 has been retracted, thereby lowering the left lift arm 73. As the right tilt cylinder 84 is extended, the top or, specifically the link 113 of the tilt lever 79 will be pushed rearward and downward, which causes the lower link 114 of the tilt lever 79 to pivot upward as shown in FIG. 3. Thus, extension of the right tilt cylinder 84 results in a raising of the right lift arm 72 and a tilt of the bucket to the left. A tilt to the left is also provided by retraction of the left tilt cylinder 85 which causes the tilt lever 81 to pivot forward and downward thereby causing the lower link 123 (not shown in FIG. 3, see FIG. 4) of the tilt lever 81 to pull the left lift arm 73 downward. Thus, FIG. 3 represents the scoop assembly 70 in a full-tilt-left position.

In contrast, FIGS. 16-17 illustrate the bucket 45 of the scoop assembly 70 in a mid-tilt-left position (FIG. 16) and a mid-tilt-right position (FIG. 17). To achieve the mid-tilt positions of FIGS. 16-17, where the tilt magnitude ranges from about 2° to about 3°, use of only one tilt cylinder 84 or 85 is needed. In other words, a full extension of the right tilt cylinder will achieve the mid-tilt-left position shown in FIG. 16. Similarly, leaving the right tilt cylinder 84 in a neutral position, a full retraction of the left tilt cylinder 85 will achieve the mid-tilt-left position shown in FIG. 16 as well. Turning to FIG. 17, to achieve the mid-tilt-right position, the left tilt cylinder 85 is fully extended while leaving the right tilt cylinder 84 in a neutral position. Similarly, the right tilt cylinder 84 is fully retracted while leaving the left tilt cylinder 85 in a neutral position to achieve the same mid-tilt-right position shown in FIG. 17.

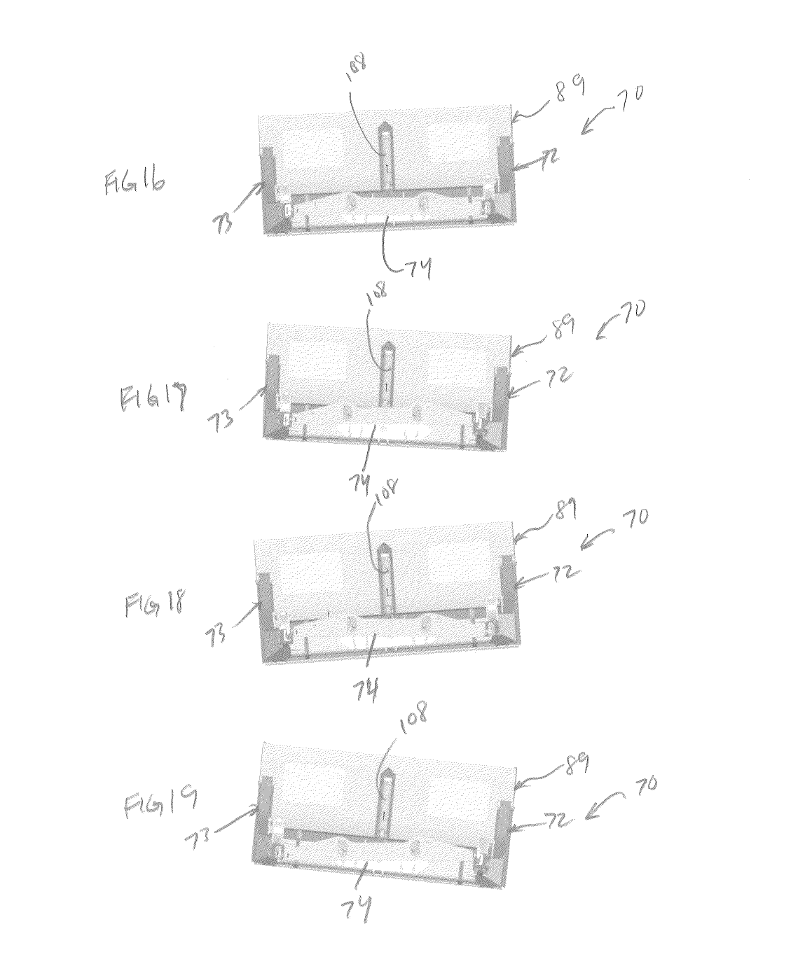

Turning to FIGS. 18-19, the bucket 45 are shown in full-tilt-left (FIG. 18) and full-tilt-right (FIG. 19) positions. To achieve the full-tilt-left position shown at FIG. 18, the right tilt cylinder 84 is fully extended and the left tilt cylinder 85 is fully retracted. The magnitude of the tilt is about twice that shown in FIG. 16 or within a range of from about 5° to about 6°. Similarly, to achieve the full-tilt-right position shown in FIG. 19, the right tilt cylinder is fully retracted while the left tilt cylinder 85 is fully extended.

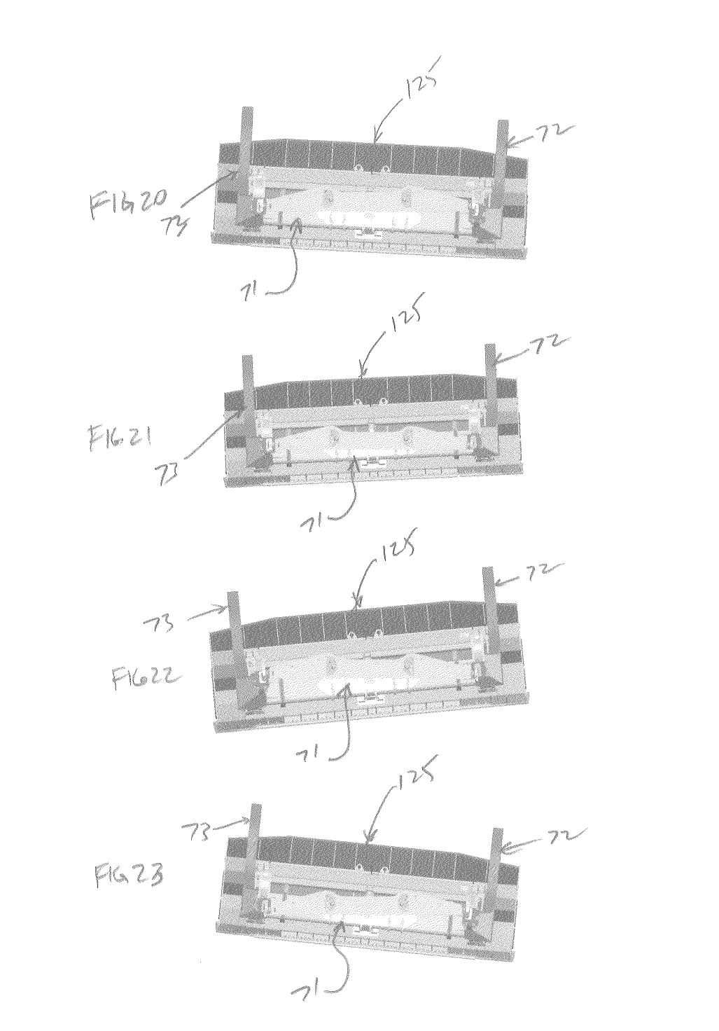

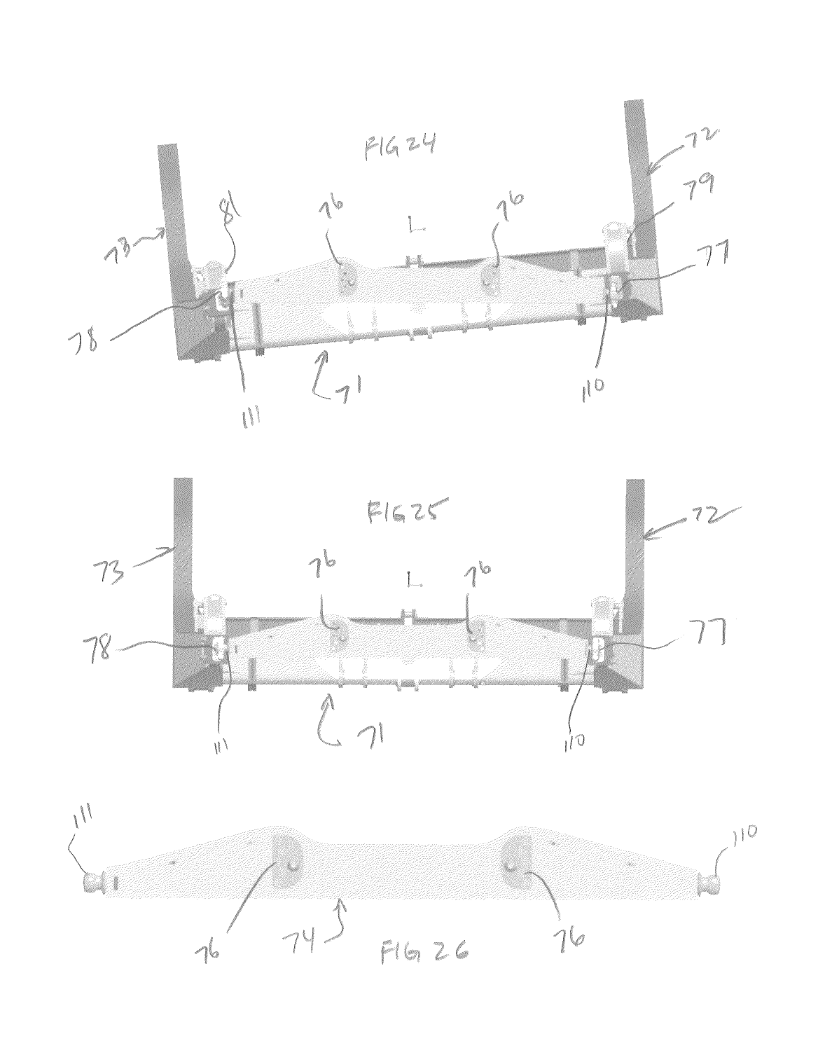

Turning to FIGS. 20-23, the same mid-tilt and full-tilt positions may be achieved with the blade 125 connected to the frame 71. FIG. 20 shows the blade in the mid-tilt-right position, which can be achieved by fully retracting the right tilt cylinder 84, fully extending the left tilt cylinder 85 or using a partial retraction of the right tilt cylinder 84 in combination with a partial extension of the left tilt cylinder 85. To achieve the mid-tilt-left position shown in FIG. 21, the right tilt cylinder 84 may be fully extended, the left tilt cylinder 85 may be fully retracted or a combination of a partial extension of the right tilt cylinder 84 and a partial retraction of the left tilt cylinder 85 may be employed. To achieve the full-tilt-left position shown in FIG. 22, the right tilt cylinder 84 may be fully extended and the left tilt cylinder 85 may be fully retracted. To achieve the full-tilt-right position shown in FIG. 23, the right tilt cylinder 84 may be fully retracted and the left tilt cylinder 85 may be fully extended.

FIGS. 24-32 illustrate the use of spherical bearings 77, 78 for maintaining a connection to the right and left trunnions 110, 111, which are fixed in place as the proximal cross beam 74 is fixed to the machine (not shown). Specifically, when the frame 71 is tilted to the left, for example, as in FIG. 24, the distance between the spherical bearings 77, 78 increases as the spherical bearings 77, 78 are no longer axially aligned with the right and left trunnions 110, 111 as illustrated in FIG. 25. To compensate for this increased distance, which may be low in terms of the percentage of the distance between the trunnions 110, 111, but which may still be a significant amount, e.g. about 18 mm, spherical bearings 77, 78 are employed which allow the bearings 77, 78 to move within the spherical bearing housing 145 as the arms 72, 73 are tilted. As shown in FIG. 29, the bearing housing 145 may include a bottom half 146 and a top half 147. The bottom and top halves 146, 147 are secured together by a pair of fasteners 148 with the bearing insert 175 sandwiched between the housing halves 146, 147.

Returning to FIGS. 24-27, the distance between the trunnions 110, 111 of the proximal cross beam 74 is, of course, fixed. Further, the position of the cross beam 74 is fixed as it may be mounted to the machine using the fasteners 76. However, when the frame 71 may be tilted, as shown in FIG. 24, the distance between the spherical bearings 77, 78 has increased as the left tilt lever 81 has pivoted forward and downward, carrying the spherical bearing assembly 78 with it and thereby driving the left tilt arm 73 downward. Simultaneously, the right tilt lever 79 has been pushed rearward by the extension of the right tilt cylinder 84 thereby causing the bottom of the right tilt lever 79 to push the lift arm 72 upward as shown in FIG. 24. Thus, due to the movement of the tilt lever 79, 81, the distance between the spherical bearings 77, 78 has increased as the spherical bearings 77, 78 are mounted to the tilt levers 79, 81. To compensate for this additional distance, and to maintain the trunnions 110, 111 within the spherical bearings 77, 78, the spherical bearing inserts 175 must permit the spherical bearing inserts 175 to slide outwardly with respect the trunnions 110, 111. By providing this additional clearance or “play”, no torque is applied to the frame 71.

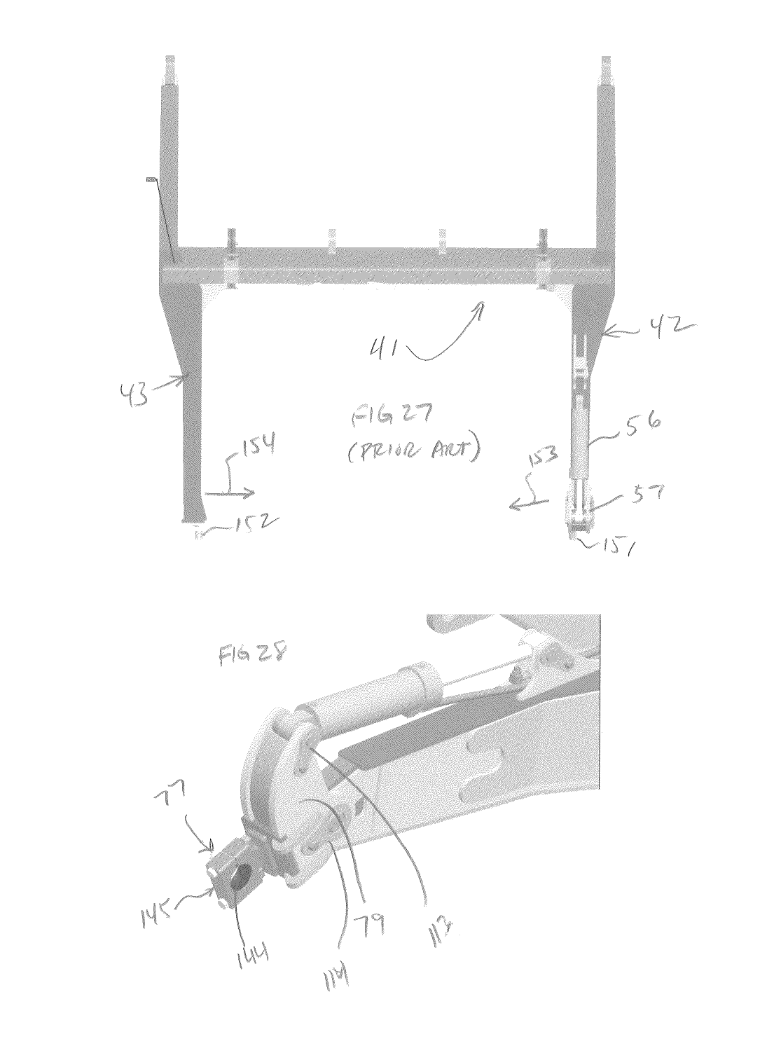

In contrast, referring to the prior art H-shaped frame 41 shown in FIG. 27, the frame 41 may include only a single tilt cylinder 56 and a single tilt lever 57. Use of a single cylinder 56 and a single lever 57 results in a moderate expansion of the distance between the conventional bearings 151, 152. However, because the trunnions 110, 111 or the end of the proximal crossbeam 74 are trapped within the bearings 151, 152, tilting the frame 41 causes the lift arms 42, 43 to be deflected inward toward each other, or in the direction of the arrows 153, 154. The additional stresses caused by the use of a second tilt cylinder will generate too much inward defective pressure on the lift arms 42, 43. As a result, the prior art frame 41 shown in FIG. 27 is only capable of tilting from about 2° to about 3° while the disclosed frame 71 is capable of tilting to within a max-tilt range of from about 5° to about 6°. The extent to which the elevation or vertical position of the spherical bearing 77 changes with respect to the lift arm 72 is illustrated in FIGS. 28 and 31. Simply put, the change in the vertical position of spherical bearing 77 is a result of the pivoting action of the tilt lever 79. The position of the tilt lever 79 in FIG. 31 along with the extension of tilt cylinder 84 results in the upward pivotal movement of the link 114 disposed at the bottom of the tilt lever 79, which thereby raises the lift arm 72. In contrast, the contraction of the tilt cylinder 84 results in a forward pivotal movement of the link 113 and downward pivotal movement of the link 114, thereby causing the right lift arm 72 to be lowered.

### INDUSTRIAL APPLICABILITY

The disclosed scoop assembly 70 provides a number of benefits over the prior art scoop assembly 40 with the typical H-shaped frame 41. For example, by positioning the dump cylinder 108 above the center of distal cross beam 75 and above the proximal portions 102, 106 of the lift arms 72, 73 and/or by disposing the dump cylinder 108 within a central pocket 94 in the curved wall 93 of the bucket 45, the dump cylinder 108 may be protected from material flow which thereby eliminates the potential for chip and coal packing between the dump cylinder and a portion of the frame or a surface of the pocket 94. The packing of wood chips and coal between a cylinder and a frame can cause cylinder damage and failure.

Further, the disclosed scoop assembly 70 requires only a single dump cylinder 108 as opposed to dual dump cylinders 47, 48 of prior art designs.

Also, by providing the hook-shaped distal portions 101, 105 of the lift arm 72, 73, the distal ends 103, 107 of the lift arms 72, 73 are raised as are the positions of the attachment pins 116, 118 on the bucket 45. The raised positions and resulting geometry constrict the position payload of the center of gravity 131. While the center of gravity 131 may be farther away from the machine than the center of gravity 132 while the buckets 79, 49 are in a resting position as shown in FIGS. 10-11 respectively, in the dump position, the center of gravity 131 may be a full 32% closer to the machine or dozer than the center of gravity 132 as illustrated in FIGS. 12-13. By placing the bucket payload center of gravity 131 closer to the machine, a drastic reduction of the shifting of the payload center of gravity 131 occurs as the load is being dumped. This is made possible by relocation of the dump cylinder 108 and the dump cylinder pin 104 closer to the payload center of gravity 131. The disclosed scoop assembly 70 also eliminates the potential of “bucket overrun”, which has the tendency to pull the dump cylinder rod 100 (FIG. 12) out of the dump cylinder 108 when a load is being dumped. The scoop assembly 70 makes this possible by shifting the payload center of gravity 131 closer to the dump cylinder 108 when the bucket 45 is in the dump position as illustrated in FIG. 12.

In summary, as illustrated in FIGS. 10-11, the higher position of the center of gravity 131, along with its more forward position in the bucket rest position results in a mechanical advantage for the frame 71 of the disclosed scoop assembly 70 of at least 5%. Further, as illustrated in FIGS. 12-13, when the bucket 45 is in a dump position, the mechanical advantage is at least 20% as the center of gravity 131 is disposed closer to the machine than the center of gravity 132 for the conventional scoop assembly 40. In one example, the center of gravity 131 for the disclosed scoop assembly 70 is about 32% closer to the machine than the center of gravity 132 as illustrated in FIGS. 12-13.

Further, when dumping the bucket 45, the cutting edge 136 of the bucket 45 will dip below the frame 71, but not as far below the frame as in the prior art design represented by the H-shaped frame 41. Specifically, the cutting edge 136 drops about 24% less than the cutting edge 137 of the bucket 49 as illustrated in FIGS. 14-15.

Also, the two tilt cylinders 84, 85 provided with the scoop assembly 70 enables twice the tipping angle (from about 5° to about 6° as opposed to from about 2° to about 3°) for the bucket 45 as well as the blade 125. This is made possible by the use of spherical bearings 77, 78 which provide a degree of translational freedom to account for the greater distances between the spherical bearings 77, 78 when the frame 71 is in a tilted position with respect to the proximal cross beam 74.

Another advantage provided by the scoop assembly 70 is that its bucket 45 may be quickly and easily replaced by a standard blade 125 as illustrated in FIGS. 5-6. The blade 125 may also be equipped with the full range of pitch angles by supplying dual pitch cylinders 127, 128, which may also be mounted to the right and left cylinder brackets 86, 87 with the tilt cylinders 84, 85 as illustrated in FIG. 6. The full range of the tilt capability of the blade 125 is illustrated in FIGS. 20-23.

In summary, the new frame 71 design with a single raised dump cylinder 108 eliminates debris packing and dump cylinder 108 binding. The new frame 71 design also constricts the range of motion of the payload center of gravity 131 and draws the payload center of gravity 131 closer to the machine for improved bucket performance. A standard blade 125 may be easily attached directly to the frame 71 for added versatility in coal and chip working operations. The full range of pitch and role motions of the blade 125 are enabled by the disclosed frame 71. The spherical bearings 77, 78 with the translational degree of freedom enables an increased tilt range for both the bucket 45 and blade 125.

What is claimed is:

1. A scoop and dozer system, comprising:
a frame, a bucket, a dump cylinder, a blade and at least one pitch cylinder;
the frame including right and left lift arms, each lift arm including a proximal end, a proximal portion and a hook shaped distal portion with the proximal portion disposed between the proximal end and the hook shaped distal portion, each hook shaped distal portion terminating at a distal end, the right and left lift arms being further coupled together by a distal cross beam;
the bucket including right and left sidewalls, the distal ends of right and left lift arms being pivotally connectable to the right and left sidewalls respectively by first and second removable links respectively;
the frame being connectable to one end of the dump cylinder, the dump cylinder having another end that is connectable to the bucket by a third removable link;
wherein, upon removal of the first through the third removable links, the bucket and dump cylinder are disconnected from the right and left lift arms and the distal cross beam;
the blade including a front and a rear, the rear being connectable to the distal cross beam by a fourth and fifth removable links; and
the at least one pitch cylinder being connectable to the frame by a sixth removable link, the at least one pitch cylinder being connectable to the rear of the blade by a seventh removable link.

2. The system of claim 1 wherein the links are interchangeable.

3. The system of claim 1 wherein the dump cylinder is connectable to the distal cross beam.

4. The system of claim 1 wherein the at least one pitch cylinder includes right and left pitch cylinders, the right pitch cylinder is connectable to the right lift arm, the left pitch cylinder is connectable to the left lift arm.

5. The system of claim 4 wherein the rear of the blade includes right and left mounts, and the right and left lift arms include right and left cylinder brackets respectively,
the right and left pitch cylinders being connectable to the right and left u-blade mounts respectively, the right and left pitch cylinders also being connectable to the right and left cylinder brackets respectively.

6. The system of claim 5 further including right and left tilt levers and right and left tilt cylinders;
the right tilt lever being pivotally connectable to the proximal end of the right lift arm, the left tilt lever being pivotally connectable to the proximal end of the left lift arm; and
the right tilt cylinder being connectable to the right tilt lever and the right cylinder bracket, the left tilt cylinder being connectable to the left tilt lever and the left cylinder bracket.

7. The system of claim 5 wherein the right and left cylinder brackets are disposed on the proximal portions of the right and left lift arms respectively.

8. The system of claim 1 wherein the right sidewall of the bucket includes a right pocket with a rear opening for receiving the distal end and at least part of the distal portion of the right lift arm, the left sidewall of the bucket includes a left pocket with a rear opening for receiving the distal end and at least part of the distal portion of the left lift arm.

9. The system of claim 1 wherein the bucket further includes a curved wall disposed between the right and left sidewalls, the curved wall including a central pocket with a rear opening for receiving at least part of the dump cylinder when the dump cylinder is detachably connected to the proximal cross beam and the bucket.

10. The system of claim 9 wherein the dump cylinder is disposed substantially in the central pocket throughout a range of motion provided by contracting and extending the dump cylinder.

11. The system of claim 9 wherein the distal ends of the right and left lift arms are connected to the right and left sidewalls along a first axis that passes through the distal ends of the right and left lift arms,
the end of the dump cylinder is connectable to the central pocket at a first point that is disposed vertically above the first axis throughout a range of motion of the bucket provided by the dump cylinder.

12. The system of claim 11 wherein the first point is disposed above the center of gravity of the bucket throughout a range of motion provided by contracting and extending the dump cylinder.

13. The system of claim 1 wherein the distal ends of the right and left lift arms have a first axis passing therethrough, and
a center of gravity of the bucket is disposed below the first axis throughout a range of motion provided by contracting and extending the dump cylinder.

14. The system of claim 1 further including a proximal cross beam having right and left ends that are pivotally coupled to the proximal ends of the right and left lift arms respectively.

15. The system of claim 6 further including a proximal cross beam having right and left ends that are pivotally coupled to the right and left tilt levers respectively.

16. The system of claim 4 wherein the right and left tilt levers are coupled to right and left spherical bearings, the right and left ends of the proximal cross beam including right and left trunnions respectively, the right and left trunnions being received in the right and left spherical bearings respectively.

17. The system of claim 16 wherein the right and left spherical bearings each include a housing and a bearing insert for receiving one of the trunnions, each housing providing a lateral translational degree of freedom for its respective bearing insert to slide within its respective housing without exiting the respective housing when the proximal ends of the right and left lift arms are tilted.

18. A scoop and dozer system, comprising:
a frame, a bucket, a dump cylinder, right and left tilt cylinders, a blade and right and left pitch cylinders;
the frame including right and left lift arms, each lift arm including a proximal end, a proximal portion and a hook shaped distal portion, each proximal portion disposed between its respective proximal end and the hook shaped distal portion, each hook shaped distal portion terminating at a distal end, the right and left lift arms being coupled together by a distal cross beam, the proximal ends of the right and left lift arms being coupled to right and left tilt levers respectively, the proximal portions of the right and left lift arms being coupled to right and left cylinder brackets respectively, the right tilt cylinder being coupled to the right tilt lever and the right cylinder bracket, the left tilt cylinder being coupled to the left tilt lever and the left cylinder bracket;
the bucket comprising right and left sidewalls and a curved wall disposed therebetween, the right sidewall including a right pocket with a rear opening for receiving the distal end and at least part of the distal portion of the right lift arm, the left sidewall including a left pocket with a rear opening for receiving the distal end and at least part of the distal portion of the left lift arm, the distal ends of right and left lift arms being pivotally connectable to the right and left sidewalls respectively while being disposed inside the right and left pockets respectively, the bucket further including a center pocket with a rear opening, the dump cylinder being pivotally connectable to the distal cross beam and the central pocket of the bucket;
wherein, upon disconnecting the dump cylinder from the distal cross beam and the central pocket and upon disconnecting the distal ends of the right and left lift arms from the right and left sidewalls respectively, the bucket and dump cylinder are disconnected from the frame;
the blade including a front and a rear, the rear being connectable to the distal cross beam, the right pitch cylinder being connectable to the right cylinder bracket and the rear of the blade, the left pitch cylinder being connectable to the left cylinder bracket and the rear of the blade.

19. The scoop and dozer system of claim 18 wherein the dump cylinder may be disposed substantially in the central pocket of the bucket throughout a range of motion provided by contracting and extending the dump cylinder.

20. A method for providing a scoop assembly and converting the scoop assembly to a dozer assembly, the method comprising:
providing a frame, a bucket and a dump cylinder, the frame including right and left lift arms, each lift arm including a proximal end, a proximal portion and a hook shaped distal portion with the proximal portion disposed between its proximal end and its hook shaped distal portion, each hook shaped distal portion terminating at a distal end, the right and left lift arms being further coupled together by a distal cross beam, the bucket including right and left sidewalls;
detachably connecting the distal ends of right and left lift arms to the right and left sidewalls respectively, detachably connecting the distal cross beam to one end of the dump cylinder and detachably connecting the other end of the dump cylinder to the bucket for form the scoop assembly;
disconnecting the right and left lift arms from the right and left sidewalls respectively and disconnecting the dump cylinder from the bucket and distal cross beam;
providing a blade including a front and a rear, and providing right and left pitch cylinders;
connecting the rear of the blade to the distal cross beam;
connecting the right pitch cylinder to the right lift arm and to the rear of the blade;
connecting the left pitch cylinder to the left lift arm and to the rear of the blade to provide the dozer assembly.
